(19) United States
(12) Patent Application Publication
(10) Pub. No.: US 2018/0098665 A1
(43) Pub. Date: Apr. 12, 2018

(54) COOKING ACCESSORY AND ELECTRICAL COOKING APPLIANCE COMPRISING A COOKING ACCESSORY

(71) Applicant: SEB S.A., ECULLY (FR)

(72) Inventors: Frédéric SEURAT, Bretigny (FR); Nicolas MUHR, Dijon (FR); Charles GAUDISSART, Dijon (FR)

(21) Appl. No.: 15/566,940

(22) PCT Filed: Apr. 14, 2016
(86) PCT No.: PCT/FR2016/050875

§ 371 Date: Oct. 16, 2017

(30) Foreign Application Priority Data
Apr. 17, 2015 (FR) 1553456

(51) Int. Cl. A47J 37/12

(52) U.S. Cl. CPC A47J 37/1295

(57) ABSTRACT

An electrical cooking appliance, notably a deep fat fryer, includes a vat, an electrical heating device and a cooking accessory including a perforated basket and a removable insert including a perforated cooking support, the insert including two opposed support members resting on a top edge of the basket when the cooking support is arranged in the basket, each support member being extended by a member for grasping extending away from the basket when the cooking support is placed in the basket. Each member for grasping stands up above the level of the top edge of the basket when the cooking support is placed in the basket.

This invention concerns cooking accessories for the cooking of food in a cooking bath.

This invention also concerns electrical cooking appliances comprising a vat to contain a cooking bath, an electrical heating device to heat the vat and/or the cooking bath, as well as a cooking accessory placed in the vat to hold the food to be cooked.

This invention concerns in particular, but not exclusively, electric deep fat fryers.

Cooking of food in a cooking bath is generally done by using a perforated cooking basket. The cooking bath may in particular consist of oil or melted fat, for making fried foods.

Certain foods or preparations may have a fragile consistency, such as, for example, potato fritters made with small pieces of pelletized potatoes, and/or a semi-liquid consistency, such as, for example, breaded foods such as croquettes made with flour, butter, milk and cheese, covered with egg and breadcrumbs. These foods or preparations must preferably be spaced apart and in a single layer in the cooking basket, in order to prevent them from breaking down during cooking and/or to prevent adjacent foods or preparations from sticking together during cooking.

Providing a removable perforated insert in a perforated cooking basket is a known method of increasing the available cooking surface area.

One objective of this invention is to propose a cooking accessory for the cooking of food in a cooking bath, which comprises a perforated basket and a perforated insert that can be removed from the basket, and which is easy to use.

Another objective of this invention is to propose a cooking accessory for the cooking of food in a cooking bath, which comprises a perforated basket and a perforated insert that can be removed from the basket, and which is economical to construct.

Another objective of this invention is to propose an electrical cooking appliance comprising a cooking accessory for the cooking of food in a cooking bath with a perforated basket and a perforated insert that can be removed from the basket, and which is easy to use.

Another objective of this invention is to propose an electrical cooking appliance comprising a cooking accessory for the cooking of food in a cooking bath with a perforated basket and a perforated insert that can be removed from the basket, and which is economical to construct.

These objectives are achieved with an electrical cooking appliance, in particular a deep fat fryer, comprising a vat to contain a cooking bath, an electrical heating device to heat the vat and/or the cooking bath, and a cooking accessory placed in the vat to hold the food to be cooked, the cooking accessory comprising a perforated basket and a removable insert comprising a perforated cooking support, the insert comprising two opposing support members resting on a top edge of the basket when the cooking support is placed in the basket, each support member being extended by a gripping member extending away from the basket when the cooking support is placed in the basket, because each gripping member stands above the level of the top edge of the basket when the cooking support is placed in the basket. This arrangement permits limiting the lateral dimensions of the insert. The two opposing support members promote good stability of the cooking support placed in the basket. The two gripping members of the insert permit easy removal of the insert from the basket. The gripping members extending the support members make construction simple and economical.

Advantageously then, each gripping member extends outside of the basket when the cooking support is placed in the basket. This arrangement facilitates access to the cooking support.

According to an advantageous embodiment, at least one of the support members comprises two bent strands which are fixed to the cooking support and which each present a support area in order to rest on the top edge of the basket when the cooking support is placed in the basket. This construction is economical and permits good stability of the insert placed in the basket.

Advantageously then, the two bent strands of at least one of the support members join together to form one of the gripping members. This construction makes it possible to form, in a simple manner, gripping members extending in a horizontal direction, for example, parallel to the top edge of the basket. Such a construction is particularly economical and makes it easy to grip the insert.

According to a preferred embodiment, each of the support members comprises two bent strands which are fixed to the cooking support and which each present a support area in order to rest on the top edge of the basket when the cooking support is placed in the basket.

Advantageously then, the two bent strands of each of the support members join together to form one of the gripping members.

Advantageously again, the basket is connected to a gripping handle. If desired, the basket can be connected to at least one other gripping handle.

Advantageously then, the gripping handle extends between the gripping members when the cooking support is placed in the basket. This arrangement simplifies the formation of the gripping members.

According to one embodiment, the electrical heating device comprises an electrical box connected to an electrical resistor extending inside the vat, and the electrical box extends between the gripping members when the cooking support is placed in the basket and the basket is placed in the vat.

Advantageously, the gripping members are arranged inside the vat when the cooking support is placed in the basket and the basket is placed in the vat. These arrangements facilitate storage of the cooking accessory. A lid provided to close the vat when the basket is in place in the vat may also be used to close the vat when the basket and the insert are in place in the vat.

These objectives are achieved with a cooking accessory for the cooking of food in a cooking bath, comprising a perforated basket and a removable insert comprising a perforated cooking support, because the insert comprises two opposing support members resting on a top edge of the basket when the cooking support is placed in the basket, each support member being extended by a gripping member extending away from the basket when the cooking support is placed in the basket. The two opposing support members promote good stability of the cooking support placed in the basket. The two gripping members of the insert permit easy removal of the insert from the basket. The gripping members extending the support members make construction simple and economical.

Advantageously then, each gripping member extends outside of the basket when the cooking support is placed in the basket. This arrangement facilitates access to the cooking support.

Advantageously again, each gripping member stands above the level of the top edge of the basket when the cooking support is placed in the basket. This arrangement permits limiting the lateral dimensions of the insert.

According to an advantageous embodiment, at least one of the support members comprises two bent strands which are fixed to the cooking support and which each present a support area in order to rest on the top edge of the basket when the cooking support is placed in the basket. This construction is economical and permits good stability of the insert placed in the basket.

Advantageously then, the two bent strands of at least one of the support members join together to form one of the gripping members. This construction makes it possible to form, in a simple manner, gripping members extending in a horizontal direction, for example, parallel to the top edge of the basket. Such a construction is particularly economical and makes it easy to grip the insert.

According to a preferred embodiment, each of the support members comprises two bent strands which are fixed to the cooking support and which each present a support area in order to rest on the top edge of the basket when the cooking support is placed in the basket.

Advantageously then, the two bent strands of each of the support members join together to form one of the gripping members.

Advantageously again, the basket is connected to a gripping handle. If desired, the basket can be connected to at least one other gripping handle.

Advantageously then, the gripping handle extends between the gripping members when the cooking support is placed in the basket. This arrangement simplifies the formation of the gripping members.

These objectives are also achieved with an electrical cooking appliance, in particular a deep fat fryer, comprising a vat to contain a cooking bath, an electrical heating device to heat the vat and/or the cooking bath, and a cooking accessory placed in the vat to hold the food to be cooked, because the cooking accessory conforms to at least one of the aforementioned characteristics.

According to one embodiment, the electrical heating device comprises an electrical box connected to an electrical resistor extending inside the vat, and the electrical box extends between the gripping members when the cooking support is placed in the basket and the basket is placed in the vat.

Advantageously, the gripping members are placed inside the vat when the cooking support is placed in the basket and the basket is placed in the vat. These arrangements facilitate storage of the cooking accessory. A lid provided to close the vat when the basket is in place in the vat may also be used to close the vat when the basket and the insert are in place in the vat.

The invention will be more fully understood by examining an embodiment example, which is in no way restrictive, illustrated in the attached figures, in which:

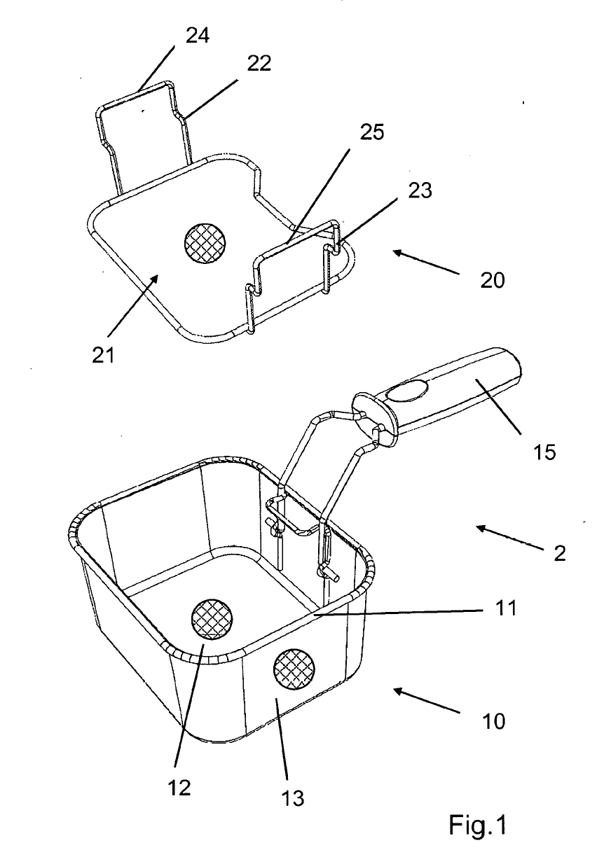

FIG. 1 is an exploded perspective view of an embodiment example of a cooking accessory according to the invention,

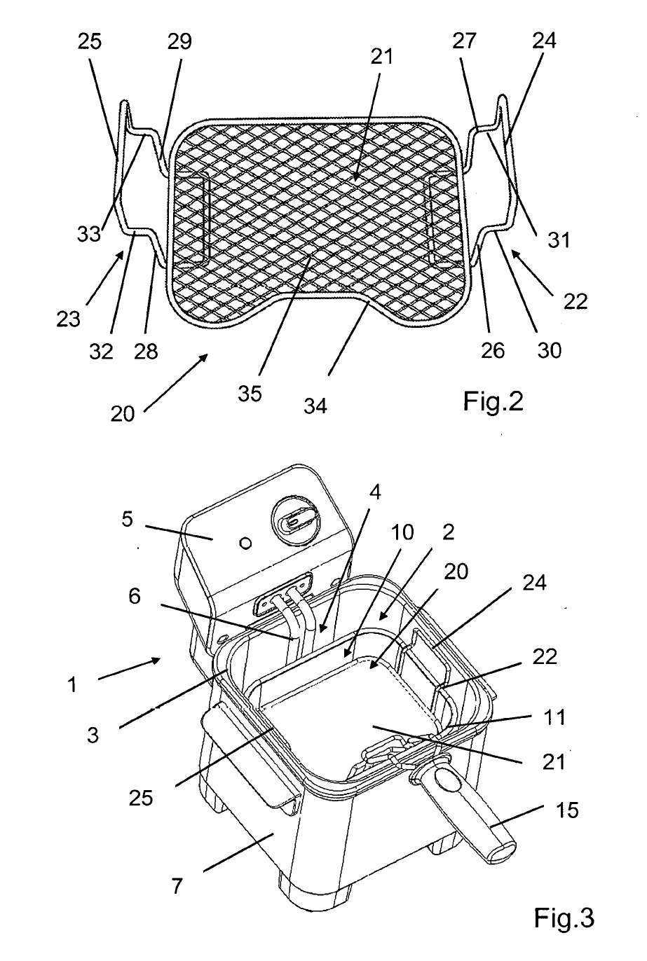

FIG. 2 is a top perspective view of an insert belonging to the cooking accessory illustrated in FIG. 1,

FIG. 3 is a top perspective view of an electrical appliance comprising the cooking accessory illustrated in FIG. 1.

A cooking accessory 2 for the cooking of food in a cooking bath illustrated in FIG. 1 comprises a perforated basket 10 and a removable insert 20. The insert 20 comprises a cooking support 21.

In the embodiment example illustrated in FIG. 1, the basket 10 comprises a top edge 11, a bottom 12 and side walls 13 connecting the bottom 12 to the top edge 11. The bottom 12 is preferably flat or substantially flat. The bottom 12 and the side walls 13 are preferably perforated. The bottom 12 and the side walls 13 are, for example, made of metal mesh, as represented schematically in FIG. 1. As a variant, other embodiments may be envisioned, in particular a perforated bottom 12 and/or side walls. To facilitate handling, the basket 10 is connected to a gripping handle 15. If desired, the gripping handle 15 may be mounted such that it is mobile in relation to the basket 10, or removable in relation to the basket 10.

In the embodiment example illustrated in FIG. 2, the cooking support 21 comprises a frame 34 containing mesh 35. The mesh 35 is preferably flat or substantially flat. As a variant, other embodiments may be envisioned, in particular a cooking support 21 that is perforated and/or comprises at least a portion of a side wall, perforated or not. If desired, the cooking support 21 can be made at least partially of perforated sheeting.

FIG. 3 illustrates an electrical cooking appliance 1 comprising the cooking accessory 2 as well as a vat 3 to contain a cooking bath and an electrical heating device 4 to heat the vat 3 and/or the cooking bath. The electrical cooking device 1 may in particular be a deep fat fryer, the vat 3 then containing an oil bath.

In the embodiment example illustrated in FIG. 3, the electrical heating device 4 comprises an electrical box 5 connected to an electrical resistor 6 extending inside the vat 3 under the basket 10. The vat 3 is arranged in an outer case 7.

As is clearly visible in FIGS. 1 and 2, the insert 20 comprises two opposing support members 22; 23. As is partially visible in FIG. 3, the support members 22; 23 rest on the top edge 11 of the basket 10 when the cooking support 21 is placed in the basket 10.

As is more visible in FIG. 2, each support member 22; 23 is extended by a gripping member 24; 25. As is visible in FIG. 3, each gripping member 24; 25 extends away from the basket 10 when the cooking support 21 is placed in the basket 10. The user may thus lift the gripping members 24; 25. Each gripping member 24; 25 extends outside of the basket 10 when the cooking support 21 is placed in the basket 10. In other words, the gripping members 24; 25 do not extend into the space extending above the basket 10. Each gripping member 24; 25 stands above the level of the top edge 11 of the basket 10 when the cooking support 21 is placed in the basket 10. In other words, the top edge 11 of the basket 10 extends below the top of the gripping members 24; 25.

According to an advantageous embodiment illustrated in the figures, at least one of the support members 22; 23 comprises two bent strands 26, 27; 28, 29 fixed to the cooking support 21. Each of the bent strands 26, 27; 28, 29 presents a support area 30, 31; 32, 33 to rest on the top edge 11 of the basket 10 when the cooking support 21 is placed in the basket 10. Preferably then, the two bent strands 26, 27; 28, 29 of at least one of the support members 22; 23 join together to form one of the gripping members 24; 25.

According to a preferred embodiment illustrated in the figures, each of the support members 22; 23 comprises two bent strands 26, 27; 28, 29 fixed to the cooking support 21. Preferably then, the two bent strands 26, 27; 28, 29 of each of the support members 22; 23 join together to form one of the gripping members 24; 25.

As is visible in FIG. 3, the gripping handle 15 extends between the gripping members 24; 25 when the cooking support 21 is placed in the basket 10. The electrical box 5 extends between the gripping members 24; 25 when the cooking support 21 is placed in the basket 10 and the basket 10 is placed in the vat 3. The gripping members 24; 25 are arranged inside the vat 3 when the cooking support 21 is placed in the basket 10 and the basket 10 is placed in the vat 3.

The cooking accessory illustrated in FIGS. 1 to 3 functions and is used in the following manner.

The user may place a first series of foods to be cooked on the bottom 12 of the basket 10 and a second series of foods to be cooked on the cooking support 21 of the insert 20. The user places the insert 20 in the basket 10 by grasping or lifting the two gripping members 24; 25. When the cooking support 21 is in place in the basket 10, the support members 22; 23 rest on the top edge 11 of the basket 10. The insert 20 is thus supported on the top edge 11 of the basket 10, without any lateral wedging. The support areas 30, 31; 32, 33 of the bent strands 26, 27; 28, 29 ensure good stability of the insert 20 in the basket 10. The user may then place the basket 10 holding the insert 20 in the vat 3 containing a cooking bath by using the gripping handle 15.

After cooking the food and removing the basket 10 holding the insert 20 from the vat 3, the user removes the insert 20 from the basket 10 by grasping or lifting the two gripping members 24; 25, if necessary with protective gloves and/or with gripping tools, according to the temperature of the gripping members 24; 25.

When the basket 10 is stored in the vat 3, the insert 20 placed in the basket 10 extends inside the vat 3, which permits closing the vat 3 with a storage lid.

The cooking accessory according to the invention is simple to produce. The cooking accessory according to the invention may in particular include an insert made to be adapted to an existing basket. The insert 20 is economical to make.

As a variant, lateral wedging of the insert 20 may be envisioned when the cooking support 21 is in place in the basket. The bent strands 26, 27; 28, 29 may, for example, be supported laterally against the basket 10, in particular against the inner face of the top edge 11.

As a variant, the support members 22; 23 and the gripping members 24; 25 are not necessarily formed by the bent strands 26, 27; 28, 29 each connected to the cooking support 21. In particular, each support member 22; 23 may be connected to the cooking support 21 by at least one bent strand.

As a variant, the support members 22; 23 and the gripping members 24; 25 are not necessarily formed of bent strands 26, 27; 28, 29. In particular, the support members 22; 23 and the gripping members 24; 25 may be formed of one or more plates presenting at least one support area to rest on the top edge 11 of the basket 10 and at least one gripping area extending away from the basket 10 when the cooking support 21 is placed in the basket 10. If desired, the insert 20 may in particular be formed in a single piece, for example, of folded perforated sheeting.

This invention is in no way limited to the embodiment example described and its variants, but encompasses many modifications in the context of the claims.

1. An electrical cooking appliance comprising a vat to contain a cooking bath, an electrical heating device to heat the vat and/or the cooking bath, and a cooking accessory placed in in the vat to hold the food to be cooked, the cooking accessory comprising a perforated basket and a removable insert comprising a perforated cooking support, the removable insert comprising two opposing support members resting on a top edge of the basket when the cooking support is placed in the basket, each support member being extended by a gripping member extending away from the basket when the cooking support is placed in the basket, wherein each gripping member stands above a level of the top edge of the basket when the cooking support is placed in the basket.

2. The electrical cooking appliance according to claim 1, wherein each gripping member extends outside of the basket when the cooking support is placed in the basket.

3. The electrical cooking appliance according to claim 1, wherein at least one of the two opposing support members comprises two bent strands which are fixed to the cooking support and which each present a support area in order to rest on the top edge of the basket when the cooking support is placed in the basket.

4. The electrical cooking appliance according to claim 3, wherein the two bent strands of at least one of the two opposing support members join together to form one of the gripping members.

5. The electrical cooking appliance according to claim 1, wherein each of the two opposing support members comprises two bent strands which are fixed to the cooking support and which each present a support area in order to rest on the top edge of the basket when the cooking support is placed in the basket.

6. The electrical cooking appliance according to claim 5, wherein the two bent strands of each of the support members join together to form one of the gripping members.

7. The electrical cooking appliance according to claim 1, wherein the basket is connected to a gripping handle.

8. The electrical cooking appliance according to claim 7, wherein the gripping handle extends between the gripping members when the cooking support is placed in the basket.

9. The electrical cooking appliance according to claim 1, wherein the electrical heating device comprises an electrical box connected to an electrical resistor extending inside the vat, and the electrical box extends between the gripping members when the cooking support is placed in the basket and the basket is placed in the vat.

10. The electrical cooking appliance according to claim 1, wherein the gripping members are arranged inside the vat when the cooking support is placed in the basket and the basket is placed in the vat.

11. A cooking accessory for the cooking of food in a cooking bath, comprising a perforated basket and a removable insert comprising a perforated cooking support, wherein the removable insert comprises two opposing support members resting on a top edge of the basket when the cooking support is placed in the basket, each support member being extended by a gripping member extending away from the basket when the cooking support is placed in the basket.

12. The cooking accessory according to claim 11, wherein each gripping member extends outside of the basket when the cooking support is placed in the basket.

13. The cooking accessory according to claim 11, wherein each gripping member stands above a level of the top edge of the basket when the cooking support is placed in the basket.

14. The cooking accessory according to claim 11, wherein at least one of the two opposing support members comprises two bent strands which are fixed to the cooking support and which each present a support area in order to rest on the top edge of the basket when the cooking support is placed in the basket.

15. The cooking accessory according to claim 14, wherein the two bent strands of at least one of the support members join together to form one of the gripping members.

16. The cooking accessory according to claim 11, wherein each of the two opposing support members comprises two bent strands which are fixed to the cooking support and which each present a support area in order to rest on the top edge of the basket when the cooking support is placed in the basket.

17. The cooking accessory according to claim 16, wherein the two bent strands of each of the two opposing support members join together to form one of the gripping members.

18. The cooking accessory according to claim 11, wherein the basket is connected to a gripping handle.

19. The cooking accessory according to claim 18, wherein the gripping handle extends between the gripping members when the cooking support is placed in the basket.

20. An electrical cooking appliance comprising a vat to contain a cooking bath, an electrical heating device to heat the vat and/or the cooking bath, and a cooking accessory placed in the vat to hold the food to be cooked, wherein the cooking accessory conforms to claim 11.

21. The electrical cooking appliance according to claim 20, wherein the electrical heating device comprises an electrical box connected to an electrical resistor extending inside the vat, and the electrical box extends between the gripping members when the cooking support is placed in the basket and the basket is placed in the vat.

22. The electrical cooking appliance according to claim 20, wherein the gripping members are arranged inside the vat when the cooking support is placed in the basket and the basket is placed in the vat.

23. The electrical cooking appliance according to claim 1, wherein the electrical cooking appliance is a deep fat fryer.

24. The electrical cooking appliance according to claim 20, wherein the electrical cooking appliance is a deep fat fryer.
